(19) United States
(12) Patent Application Publication
(10) Pub. No.: US 2020/0242740 A1
(43) Pub. Date: Jul. 30, 2020

(54) WIDE SPECTRUM DENOISING METHOD FOR MICROSCOPIC IMAGES

(71) Applicant: GUANGXI UNIVERSITY OF SCIENCE AND TECHNOLOGY, Liuzhou (CN)

(72) Inventor: Tao CHENG, Liuzhou (CN)

(73) Assignee: GUANGXI UNIVERSITY OF SCIENCE AND TECHNOLOGY

(21) Appl. No.: 16/845,110

(22) Filed: Apr. 10, 2020

Related U.S. Application Data
(63) Continuation of application No. PCT/CN2019/127308, filed on Dec. 23, 2019.

(30) Foreign Application Priority Data
Dec. 17, 2019 (CN) 201911303478.0

(51) Int. Cl. G06T 5/00

(52) U.S. Cl. CPC G06T 5/002; G06T 2207/10056

(57) ABSTRACT

The present invention discloses a wide spectrum denoising method for microscopic images, comprising: connecting a sub-block image matrix end to end to convert same into a one-dimensional vector y_{raw}; performing iterative optimization processing on a measurement matrix A to obtain an optimization matrix Aₒ; calculating a transition matrix T based on the measurement matrix A and the optimization matrix Aₒ, and performing singular value decomposition on the transition matrix T to obtain USV^{T}; compressing the value greater than the threshold in SV^{T}y_{raw} to the threshold, and unchanging the value less than the threshold, thus achieving the purpose of denoising; finally, left multiplying the noise-suppressed y′ₛᵥ by T⁻¹U to obtain denoised Y_{WSD}, then cutting off overlapping parts of edges, and splicing a complete denoised image row by row or column by column.

### TECHNICAL FIELD

The present invention relates to the technical field of image denoising, in particular to a wide spectrum denoising method for microscopic images.

### BACKGROUND

The noise of a Stochastic Optical Reconstruction Microscopy (STORM) raw image acquired by an Electronic-Multiplying Charge-Coupled Device (EMCCD) mainly includes shot noise following Poisson distribution, readout noise following Gaussian distribution and background.

Improving temporal and spatial resolution has always been the focus of STORM research. The presence of noise makes the effective pixel size of a camera must be approximately equal to the standard deviation of the PSF of an imaging system, so as to obtain a good single molecule localization effect. This tradition is also continued in the STORM research based on compressed sensing (CS). If a high-resolution camera is used (the effective pixel of the camera is much smaller than the standard deviation of the PSF), the number of photons received by each camera pixel may be too few, resulting in increased noise, thus sharply reducing the localization accuracy. Each single molecule localization algorithms' anti-noise capability is not strong, so the raw images acquired by the high-resolution camera cannot be effectively used. CS can realize the acquirement and reconstruction of raw images of high-density fluorescent molecules, greatly improving the temporal and spatial resolution.

If various noise of the raw images can be effectively denoised, the temporal and spatial resolution based on CS or other theories can be further improved; and the manufacturing and popularization costs and the experimental operation difficulties of related instruments and equipment can be further reduced.

At present, there are many excellent high-performance denoising algorithms in the field of microscopy and image processing, such as BM3D for Gaussian noise, GAV for Poisson-Gaussian mixed noise (the generalized Anscombe variance-stabilizing transformation is used to denoise, MAKITALO M, FOI A. Optimal inversion of the generalized Anscombe transformation for Poisson-Gaussian noise [J]. IEEE transactions on image processing, 2012, 22(1): 91-103.), etc.

However, there are few reports about denoising a raw image before localization in various published fluorescent molecular localization references. Although single molecule localization algorithms such as Photoactivated Localization Microcopy (PALM), etc. may perform some bandpass filter processing on the raw image before localization, the raw image may lose a lot of information, which is not suitable for CS reconstruction and calculation. For the CS-based STORM, the raw image is not denoised, and the raw image minus the baseline is directly used, which cannot give full play to the potential of CS. The noise of the original raw is dominated by Poisson noise and mixed with various other noise. Although EMCCD camera performance is getting better and better, readout noise and the like still exist.

Therefore, it is an urgent problem to be solved by those skilled in the art about how to provide a more efficient denoising method for microscopic images.

### SUMMARY

In view of this, the present invention provides a wide spectrum denoising method for microscopic images, which is more efficient, can be suitable for various random noise, and has denoising performance not affected by the distribution density of fluorescent molecules.

To achieve the above purpose, the present invention adopts the following technical solution: a wide spectrum denoising method for microscopic images, comprising the following steps:

S1: extracting sub-block images with overlapping edges of a pre-acquired raw image row by row or column by column to obtain a sub-block image matrix Y_{raw};

S2: concatenating the column/row-wise sub-block image matrix Y_{raw} to obtain a one-dimensional vector y_{raw};

S3: performing iterative optimization processing on a pre-acquired measurement matrix A to obtain an optimization matrix A_{O}, wherein the measurement matrix A is determined by a point spread function of the imaging system;

S4: calculating a transition matrix T based on the measurement matrix A and the optimization matrix A_{O}, and performing singular value decomposition on the transition matrix T to obtain USV^{T};

S5: calculating based on the SV^{T} and the one-dimensional vector y_{raw} to obtain a one-dimensional vector y_{SV}=SV^{T}y_{raw};

S6: comparing each element value in the one-dimensional vector y_{SV} with the threshold cri, and if it is greater than the threshold cri, setting the element value to cri to obtain y′_{SV′},

S7: calculating a noise-suppressed one-dimensional vector y_{WSD}=T⁻¹(Uy′ₛᵥ);

S8: reshaping the noise-suppressed one-dimensional vector y_{WSD} according to the number of rows and columns of the two-dimensional image matrix Y_{raw}, to obtain a denoised two-dimensional image matrix Y_{WSD}; and

S9: based on the denoised two-dimensional image matrix Y_{WSD}, cutting off the overlapping parts of edges, and splicing a complete denoised image row by row or column by column.

Preferably, step S3 specifically comprises:

performing orthogonal normalization processing on each row of the measurement matrix A, performing normalization processing on each column, completing one processing to obtain a new measurement matrix, and performing N1 times of iteration processing based on the new measurement matrix to obtain an optimization matrix A_{O};

alternatively,

performing orthogonal normalization processing on each row of the measurement matrix A to obtain the optimization matrix A_{O}.

Preferably, the point spread function comprises a Gaussian function, a Bessel function, a PSF generated by the imaging system or a PSF obtained by fitting experimental data.

Preferably, the threshold cri is the maximum of absolute values from the element iₛₜₐᵣ to the element iₜₐᵢₗ in the one-dimensional vector y_{SV},

where iₛₜₐᵣ is the nearest integer less than or equal to M×star, iₜₐᵢₗ is the nearest integer less than or equal to M×tail, M is the number of rows of the measurement matrix A, star is the starting value, and tail is the tail value. Preferably, star is 0.7, and tail is 1.

Preferably, star is 0.9, and tail is 0.95.

According to the above-mentioned technical solution, compared with the prior art, the present invention discloses a wide spectrum denoising method for microscopic images, in which the value greater than the threshold in SV^{T}y_{raw} is compressed to the threshold, and the value less than the threshold is unchanged, thus achieving the purpose of denoising, finally, the noise-suppressed y′_{SV} is left multiplied by T⁻¹U to obtain denoised Y_{WSD}, then overlapping parts of edges are cut off, and a complete denoised image is spliced row by row or column by column.

Moreover, the wide spectrum denoising method for microscopic images provided by the present invention is suitable for various random noise and has denoising performance not affected by the distribution density of fluorescent molecules.

### BRIEF DESCRIPTION OF THE ACCOMPANYING DRAWING

In order to more clearly explain the embodiments of the present invention or the technical solution in the prior art, the embodiments or drawings required in the description of the prior art will be briefly introduced below. Obviously, the drawings in the description below are only some embodiments of the present invention. Those ordinary skilled in the art may also obtain other drawings according to the provided drawings without contributing creative labor.

FIG. 1 shows comparative analysis of denoising effects of simulated STORM raw images based on various methods provided by the present invention;

FIG. 2 is a schematic diagram showing denoising analysis of simulated STORM raw images based on WSD provided by the present invention;

FIG. 3 is a schematic diagram showing denoising and reconstruction results of a real STORM raw image based on WSD and CVX provided by the present invention;

FIG. 4 is a schematic diagram showing reconstruction results of real STORM raw images of low-density fluorescent molecules based on WSD and PALM algorithms before and after denoising provided by the present invention; and

FIG. 5 is a flow chart of a wide spectrum denoising method for microscopic images provided by the present invention.

### DETAILED DESCRIPTION OF THE PRESENT INVENTION

The technical solution in the embodiment of the present invention will be described clearly and completely below in combination with the drawings in the embodiments of the present invention. Obviously, the described embodiments are only a part of the embodiments of the present invention, but not all of the embodiments. Based on the embodiments of the present invention, all other embodiments obtained by those ordinary skilled in the art without contributing creative labor belong to the protection scope of the present invention.

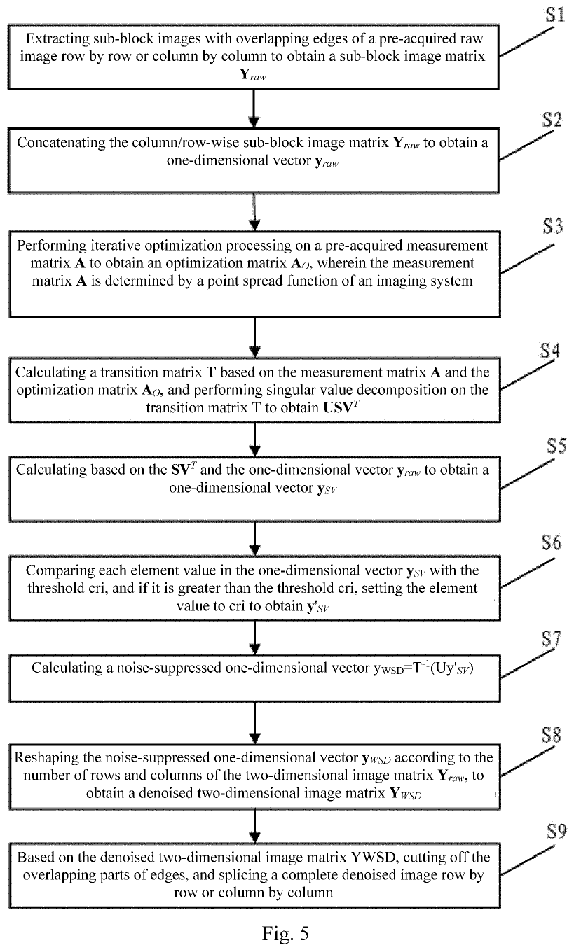

As shown in FIG. 5, embodiments of the present invention disclose a wide spectrum denoising method for microscopic images, comprising the following steps:

S1: extracting sub-block images with overlapping edges of a pre-acquired raw image row by row or column by column to obtain a sub-block image matrix Y_{raw};

S2: concatenating the column/row-wise sub-block image matrix Y_{raw} to obtain a one-dimensional vector y_{raw};

S3: performing iterative, optimization processing on a pre-acquired measurement matrix A to obtain an optimization matrix A_{O}, wherein the measurement matrix A is determined by a point spread function of an imaging system;

S4: calculating a transition matrix T based on the measurement matrix A and the optimization matrix A_{O}, and performing singular value decomposition on the transition matrix T to obtain USV^{T};

S5: calculating based on the SV^{T} and the one-dimensional vector y_{raw} to obtain a one-dimensional vector y_{SV}=SV^{T}y_{raw};

S6: comparing each element value in the one-dimensional vector y_{SV} with the threshold cri, and if it is greater than the threshold cri, setting the element value to cri to obtain Y′_{SV′};

S7: calculating a noise-suppressed one-dimensional vector y_{WSD}=T⁻¹(Uy′_{SV});

S8: reshaping the noise-suppressed one-dimensional vector y_{WSD} according to the number of rows and columns of the two-dimensional image matrix Y_{raw}, to obtain a denoised two-dimensional image matrix Y_{WSD}, and

S9: based on the denoised two-dimensional image matrix Y_{WSD}, cutting off the overlapping parts of edges, and splicing a complete denoised image row by row or column by column.

In order to further optimize the above technical solution, step S3 specifically comprises:

performing orthogonal normalization processing on each row of the measurement matrix A, performing normalization processing on each column, completing one processing to obtain a new measurement matrix, and performing N1 times of iteration processing based on the new measurement matrix to obtain an optimization matrix A_{O};

alternatively,

performing orthogonal normalization processing on each row of the measurement matrix A to obtain the optimization matrix A_{O}.

In order to further optimize the above technical solution, the point spread function comprises a Gaussian function, a Bessel function, a PSF generated by the imaging system or a PSF obtained by fitting experimental data.

In order to further optimize the above technical solution, the threshold cri is the maximum of absolute values from the element iₛₜₐᵣ to the element iₜₐᵢₗ in the one-dimensional vector y_{SV′},

where iₛₜₐᵣ is the nearest integer less than or equal to M×star, iₜₐᵢₗ is the nearest integer less than or equal to M×tail, M is the number of rows of the measurement matrix A, star is the starting value, and tail is the tail value. In order to further optimize the above technical solution, star is 0.7, and tail is 1. Preferably, star is 0.9, and tail is 0.95.

The present invention develops a denoising method for microscopic images, which is theoretically suitable for various random noise and has denoising performance not affected by the distribution density of fluorescent molecules, and is called a Wide Spectrum Denoising (WSD) method. Various random noise and signals naturally have orthogonality, and the theoretical basis of WSD is to use the orthogonality of the two. Experiments show that WSD can be used in the distribution of fluorescent molecules from extremely low density to ultra-high density, and can improve the SNR of a raw image by about 7 dB. After denoising raw images, when using the CVX of CS for reconstruction, only 20 raw images are needed, with a temporal resolution of 0.8614 seconds, which reaches a sub-second temporal resolution.

In order to illustrate the effectiveness of the wide spectrum denoising method for microscopic images provided by the present invention, the CVX technology of compressed sensing (CS) is used for verification.

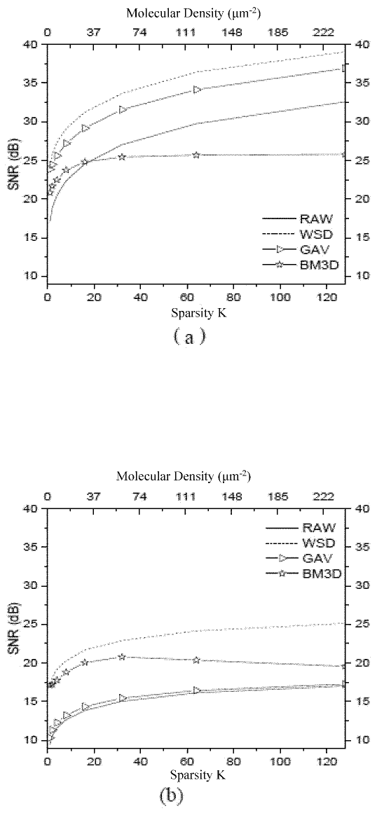

RAW in FIG. 1 indicates a simulated raw image; WSD indicates that the simulated raw image is denoised using WSD; GAV indicates that the simulated raw image is denoised using GAV; and BM3D indicates that the simulated raw image is denoised using BM3D. At different molecular density and sparsity (i.e. the number of molecules in each simulation, K=1, 2, 4, 8, 16, 32, 64, 128), 500 times of simulation are performed respectively to calculate all curves of the average signal-to-noise ratio. The x axis represents molecular density and signal sparsity K. The y-axis represents the signal-to-noise ratio (SNR). The simulated average photon number is 3000 per molecule and the number of photons of the background is 16 per pixel, with Poisson noise. The simulation in Fig. (a) does not contain Gaussian noise; the simulation in Fig. (b) contains Gaussian noise with a variance of 0.01; and the simulation in Fig. (c) contains Gaussian noise with a variance of 0.001. As shown in FIG. 1, WSD is located at the top of all curves.

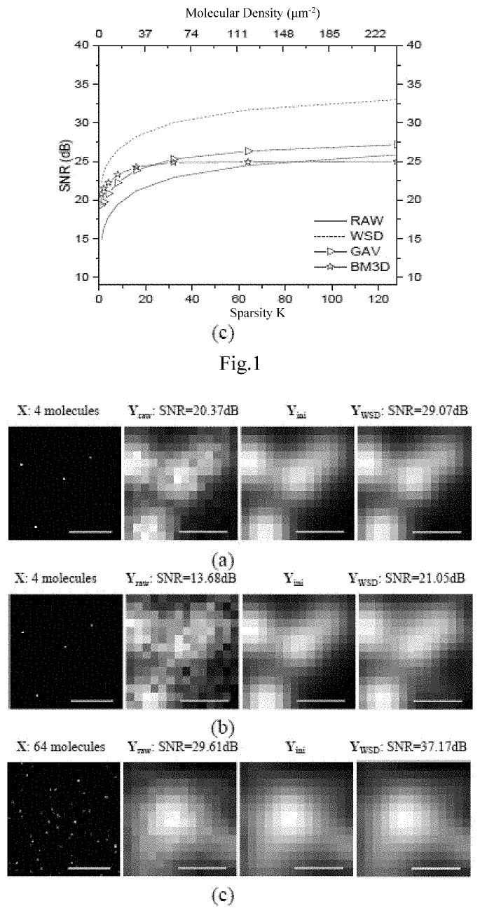

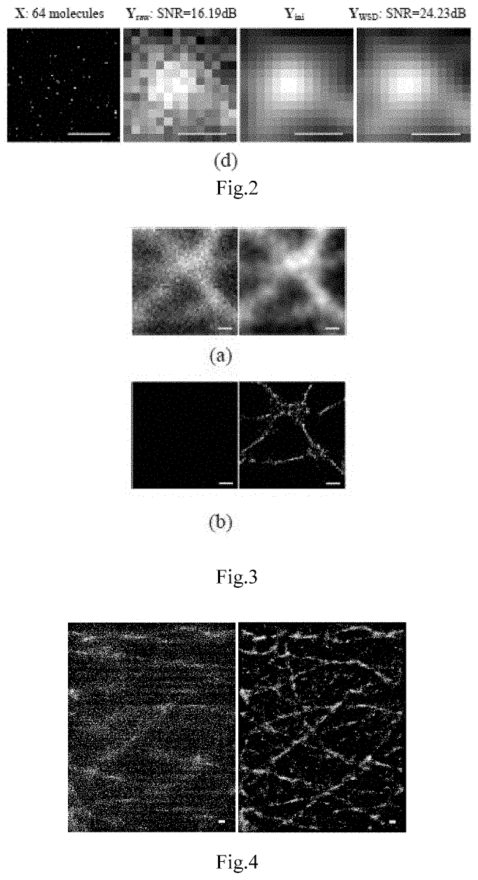

FIG. 2 shows a simulated raw image X, a noisy raw image Y_{raw}, a noiseless raw image Yin, and a denoised raw image Y_{WSD} by WSD from left to right. The simulated average photon number is 3000 per molecule and the number of photons of the background is 16 per pixel, with Poisson noise. FIGS. 2(a) and 2(b) contain 4 molecules, which show denoising analysis of a STORM image containing 4 molecules based on compressive sensing; and FIGS. 2(c) and 2(d) contain 64 molecules, which show denoising analysis of a STORM image containing 64 molecules based on compressive sensing. FIGS. 2(b) and 2(d) additionally contain Gaussian noise with a variance of 0.01. Comparing Y_{WSD} with Yᵢₙᵢ, it is shown that Y_{WSD} is very similar to Yᵢₙᵢ. The scale is 274 nm. Through comparison, it is found that the denoising method provided by the present invention can effectively improve the signal-to-noise ratio, which fully shows that the denoising method provided by the present invention is suitable for various random noise and has denoising performance not affected by the distribution density of fluorescent molecules.

FIG. 3(a) shows one real raw image and a denoised raw image by WSD from left to right. FIG. 3(b) shows superposition effect figures of 20 real raw images and denoised raw image reconstructed using the CVX algorithm from left to right, with a scale of 274 nm. The figure on the left of FIG. 3(b) is the reconstruction result of the figure on the left of FIG. 3(a), and the entire figure on the left of FIG. 3(b) is black, indicating that reconstruction fails. The figure on the right of FIG. 3(b) is the reconstruction result of the figure on the right of FIG. 3(a), indicating that the denoised raw image can be reconstructed, and fully indicating that the denoising method provided by the present invention is effective.

FIG. 4 shows superposition effect figures of 10,000 real raw images and denoised raw images reconstructed using the PALM algorithm from left to right, with a scale of 274 nm. Through comparison, it is found that the reconstruction effect after denoising is better.

In addition, it should be noted that the horizontal line in the lower right corner of the experimental result map is a scale of 274 nm.

Each embodiment in the description is described in a progressive way. The difference of each embodiment from each other is the focus of explanation. The same and similar parts among all of the embodiments can be referred to each other. For the apparatus embodiments, because the apparatus embodiments are generally similar to the method embodiments, the apparatus embodiments are simply described. Refer to part of the description of the method embodiments for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. A wide spectrum denoising method for microscopic images, comprising:
S1: extracting sub-block images with overlapping edges of a pre-acquired raw image row by row or column by column to obtain a sub-block image matrix Y_{raw};
S2: concatenating the column/row-wise sub-block image matrix Y_{raw} to obtain a one-dimensional vector y_{raw};
S3: performing iterative optimization processing on a pre-acquired measurement matrix A to obtain an optimization matrix A_{O}, wherein the measurement matrix A is determined by a point spread function of an imaging system;
S4: calculating a transition matrix T based on the measurement matrix A and the optimization matrix A_{O}, and performing singular value decomposition on the transition matrix T to obtain USV^{T};
S5: calculating based on the SV^{T} and the one-dimensional vector y_{raw} to obtain a one-dimensional vector y_{SV}=SV^{T}y_{raw};
S6: comparing each element value in the one-dimensional vector y_{SV} with the threshold cri, and if it is greater than the threshold cri, setting the element value to cri to obtain y′_{SV′};
S7: calculating a noise-suppressed one-dimensional vector y_{WSD}=T⁻¹(Uy′_{SV});
S8: reshaping the noise-suppressed one-dimensional vector y_{WSD} according to the number of rows and columns of the two-dimensional image matrix Y_{raw}, to obtain a denoised two-dimensional image matrix Y_{WSD}; and
S9: based on the denoised two-dimensional image matrix Y_{WSD}, cutting off the overlapping parts of edges, and splicing a complete denoised image row by row or column by column.

2. The wide spectrum denoising method for microscopic images according to claim 1, characterized in that step S3 specifically comprises:
performing orthogonal normalization processing on each row of the measurement matrix A, performing normalization processing on each column, completing one processing to obtain a new measurement matrix, and performing N1 times of iteration processing based on the new measurement matrix to obtain an optimization matrix A_{O};
alternatively,
performing orthogonal normalization processing on each row of the measurement matrix A to obtain the optimization matrix A_{O}.

3. The wide spectrum denoising method for microscopic images according to claim 1, characterized in that the point spread function comprises a Gaussian function, a Bessel function, a PSF generated by the imaging system or a PSF obtained by fitting experimental data.

4. The wide spectrum denoising method for microscopic images according to claim 2, characterized in that the point spread function comprises a Gaussian function, a Bessel function, a PSF generated by the imaging system or a PSF obtained by fitting experimental data.

5. The wide spectrum denoising method for microscopic images according to claim 1, characterized in that the threshold cri is the maximum of absolute values from the element iₛₜₐᵣ to the element iₜₐᵢₗ in the one-dimensional vector y_{SV},
where iₛₜₐᵣ is the nearest integer less than or equal to M×star, iₜₐᵢₗ is the nearest integer less than or equal to M×tail, M is the number of rows of the measurement matrix A, star is the starting value, and tail is the tail value.

6. The wide spectrum denoising method for microscopic images according to claim 5, characterized in that star is 0.7, and tail is 1.

7. The wide spectrum denoising method for microscopic images according to claim 5, characterized in that star is 0.9, and tail is 0.95.
